(19) United States
(12) Patent Application Publication
(10) Pub. No.: US 2026/0010221 A1
(43) Pub. Date: Jan. 8, 2026

(54) APPARATUS WITH ADAPTIVE POWER MANAGEMENT MECHANISM AND METHODS FOR OPERATING THE SAME

(71) Applicant: Micron Technology, Inc., Boise, ID (US)

(72) Inventors: Marco Onorato, Concorezzo (IT); Luca Porzio, Casalnuovo Di Napoli (IT); Paolo Amato, Treviglio (IT); Roberto Izzi, Caserta (IT); Antonino Pollio, Vico Equense (IT)

(21) Appl. No.: 19/261,766

(22) Filed: Jul. 7, 2025

Related U.S. Application Data
(60) Provisional application No. 63/668,770, filed on Jul. 8, 2024.

(51) Int. Cl. G06F 1/3234; G06F 1/3225; G06F 1/3228; G06F 1/3296

(52) U.S. Cl. CPC G06F 1/3275; G06F 1/3225; G06F 1/3228; G06F 1/3296

(57) ABSTRACT

Disclosed herein are methods, apparatuses and systems related to adjusting memory operations according to a usage pattern or a contextual parameter. The apparatus may be configured to track an operating measure associated with operating in an active operating mode and a switching measure associated with a transition into a reduced power mode. Based on the tracked measures, the apparatus may be configured to dynamically adjust a delay used in subsequently transitioning into the reduced power mode.

### CROSS-REFERENCE TO RELATED APPLICATION(S)

The present application claims priority to U.S. Provisional Patent Application No. 63/668,770, filed Jul. 8, 2024, the disclosure of which is incorporated herein by reference in its entirety.

### TECHNICAL FIELD

The disclosed embodiments relate to devices, and, in particular, to semiconductor memory devices with adaptive power management mechanism and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. However, the performance or characteristics of the memory devices can be affected by usage and demand.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2 is an illustration of a control profile in accordance with an embodiment of the present technology.

FIG. 3A is a flow diagram illustrating a first example method of operating an apparatus in accordance with an embodiment of the present technology.

FIG. 3B is a flow diagram illustrating a second example method of operating an apparatus in accordance with an embodiment of the present technology.

FIG. 4 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for dynamically adjusting power control parameters according to actual usage. For example, a memory system can balance active operations and the corresponding power consumption with reduced-power operations and the corresponding access to memory.

Memory systems, such as in automotive applications, face a challenging requirement in relation to the maximizing operative lifetime. For example, regarding power management, the on-time (e.g., a total duration of targeted circuits having power or operating in active mode) and the maximum number of ON/OFF or power-related states affect or limit the life span of the memory systems. In some embodiments, such as in automotive applications, the end-of-life (EOL) requirement can include an operating time of 50,000 hours, 60,000 hours, or more or a corresponding lifespan (e.g., estimated 12-year span, 15-year span, or more). The EOL requirement can further include limiting the transitions in power-related operating states to 15 million transitions, 20 million transitions, or more, or the corresponding lifespan.

Some of the EOL requirements can have opposing or inverse effects that require balancing to prolong the lifespan of the overarching device/system. For example, the operating time and the corresponding power consumption of a memory device can be reduced by transitioning the device/system to a reduced-power state, such as by removing or reducing power to one or more of the components therein. In transitioning the operating state, the memory device can store details of the previous operating state, conditions, parameters, data, or the like so that the information required to re-establish and continue the operation can be stored and maintained across the lowered/removed power. However, accessing persistent memory can often wear down and degrade the storage capacity of the memory cells. As such, the memory device is required to balance the operating time and the operating state transitions to extend or maximize the lifespan.

In balancing the opposing EOL requirements, the memory device can face additional and often dynamic challenges arising from the variety in applicable implementations, the variety of operating conditions within each of the implementations, and/or the different usage patterns under or across the variety of operating conditions. For example, a memory device may be manufactured for a general purpose and can be implemented in any one of a personal computing device, an enterprise computing device, a server, a vehicle, a machine/robot, or the like. Moreover, the memory device may be implemented under different environmental conditions, such as surrounding facilities, weather patterns, system packaging, surrounding components, or the like, that influence the physical state (e.g., internal temperatures and wear) of the memory device. Further, the different users of the overarching application can subject the memory device to different operating patterns, such as for activity frequency/duration. Using automotive or vehicle applications as an illustration, a vehicle having the memory device therein can target operation in a number of different geographic regions and the corresponding weather patterns. Moreover, depending on the user's needs, the vehicle may be subject to stop-and-go traffic, relatively short commutes (e.g., less than 10 minutes between ignition on and off), long distance/duration driving, automatic engine-shut off, different numbers of activated accessory or non-driving features, and other user-dependent operating conditions.

To manage competing operating interests under such dynamic conditions, embodiments of the technology described herein can include a power control mechanism that can track, in real-time, an operating measure and a switching measure for a memory system. The power control mechanism can be configured to compare the tracked operating and switching measures and use the comparison to dynamically adjust a trigger used to transition the memory system into a reduced power state. For example, the memory system can be configured (e.g., using a counter) to transition into the reduced power state after a triggering duration of inactivity, such as measured from a command last-received from a host device. The memory system can increase or decrease the triggering duration based on the comparison between the operating measure (e.g., a tracked on or active duration for one or more of the components) and the switching measure (e.g., a tracked number of transitions between power states).

Accordingly, the power control mechanism dynamically adjust and balance the competing EOL requirements, such as the total operating time and the memory cell wear caused by the power transitions, according to the actual operating conditions. By dynamically balancing according to actual real-time conditions, the power control mechanism can balance the competing EOL requirements and prolong the overall life of the memory system.

### Example Environment

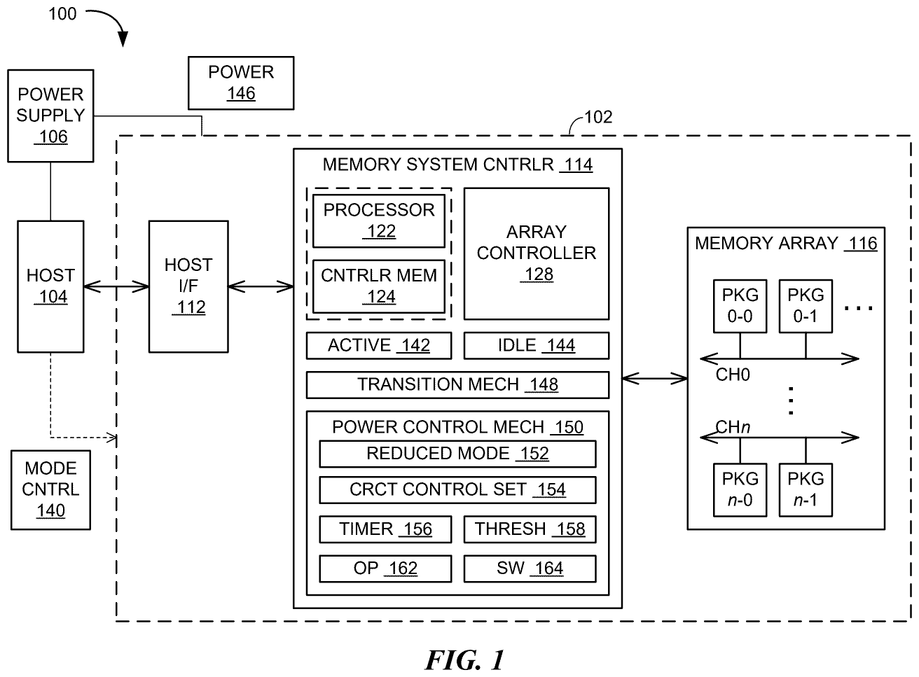

FIG. 1 is a block diagram of a computing system 100 in accordance with an embodiment of the present technology. The computing system 100 can include a personal computing device/system, an enterprise system, a mobile device, a server system, a database system, a distributed computing system, or the like. In some embodiments, the computing system 100 can include a vehicle management system, such as for operating an automobile, a watercraft, an aircraft, an autonomous vehicle, or the like.

The computing system 100 can have a memory system 102 coupled to a host device 104. The host device 104 can include one or more system processors that can write data to and/or read data from the memory system 102. For example, the host device 104 can include an upstream central processing unit (CPU). Also, for example, the host device 104 can be configured to control operation of a corresponding structure or system, such as other components (not shown) of the computing system 100 or structures operably coupled to the computing system (e.g., the vehicle or subsystems therein). The memory system 102 and the host device 104 can be powered by a power supply 106.

The memory system 102 can include circuitry configured to store data (via, e.g., write operations) and provide access to stored data (via, e.g., read operations). For example, the memory system 102 can include a persistent or non-volatile data storage system, such as a NAND-based Flash drive system, an SSD system, an SD card, or the like. In some embodiments, the memory system 102 can correspond to a Universal Flash Storage (UFS) device.

The memory system 102 can include a host interface 112 (e.g., buffers, transmitters, receivers, and/or the like) configured to facilitate communications with the host device 104. The host interface 112 can be configured to support one or more host interconnect schemes, such as Universal Serial Bus (USB), Peripheral Component Interconnect (PCI), Serial AT Attachment (SATA), or the like. The host interface 112 can receive commands, addresses, data (e.g., write data), and/or other information from the host device 104. The host interface 112 can also send data (e.g., read data) and/or other information to the host device 104. In some embodiments, the host interface 112 can be configured to implement the UFS protocols in communicating with the host device 104.

The memory system 102 can further include a memory system controller 114 (also called a micro controller) and a memory array 116. The memory array 116 can include memory cells that are configured to store a unit of information. The memory system controller 114 can be configured to control the overall operation of the memory system 102, including the operations of the memory array 116.

In some embodiments, the memory array 116 can include a set of persistent memory (e.g., NAND) devices, packages, dies, or the like. Each of the packages can include a set of memory cells that each store data in a charge storage structure. The memory cells can include, for example, floating gate, charge trap, phase change, ferroelectric, magnetoresistive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate the Vt of the cell. For example, a single level cell (SLC) can be programmed to a targeted one of two different data states, which can be represented by the binary units 1 or 0. Also, some flash memory cells can be programmed to a targeted one of more than two data states. Multilevel cells (MLCs) may be programmed to any one of four data states (e.g., represented by the binary 00, 01, 10, 11) to store two bits of data. Similarly, triple level cells (TLCs) may be programmed to one of eight (i.e., 23) data states to store three bits of data, and quad level cells (QLCs) may be programmed to one of 16 (i.e., 24) data states to store four bits of data.

Such memory cells may be arranged in rows (e.g., each corresponding to a word line 143) and columns (e.g., each corresponding to a bit line). The arrangements can further correspond to different groupings for the memory cells. For example, each word line can correspond to one or more memory pages. Also, the memory array 116 can include memory blocks that each include a set of memory pages. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

While the memory array 116 is described with respect to the memory cells, it is understood that the memory array 116 can include other components (not shown). For example, the memory array 116 can also include other circuit components, such as multiplexers, decoders, buffers, read/write drivers, address registers, data out/data in registers, etc., for accessing and/or programming (e.g., writing) the data and for other functionalities.

As described above, the memory system controller 114 can be configured to control the operations of the memory array 116. The memory system controller 114 can include a processor 122, such as a special purpose logic circuitry (e.g., a field programmable gate array (FPGA), an application specific integrated circuit (ASIC), etc.), a microprocessor, or other suitable processor. The processor 122 can execute instructions encoded in hardware, firmware, and/or software (e.g., instructions stored in controller embedded memory 124 to execute various processes, logic flows, and routines for controlling operation of the memory system 102 and/or the memory array 116.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

In controlling the operations of the memory system 102, the memory system controller 114 (via, e.g., the processor 122, the embedded memory 124, and/or the array controller 128) can implement a Flash Translation Layer (FTL). The FTL can include a set of functions or operations that provide translations for the memory array 116 (e.g., the Flash devices therein). For example, the FTL can include the logical-physical address translation, such as by providing the mapping between virtual or logical addresses used by the operating system to the corresponding physical addresses that identify the Flash device and the location therein (e.g., the layer, the page, the block, the row, the column, etc.). Also, the FTL can include a garbage collection function that extracts useful data from partially filed units (e.g., memory blocks) and combines them to a smaller set of memory units. The FTL can include other functions, such as wear-leveling, bad block management, concurrency (e.g., handling concurrent events), page allocation, error correction code (e.g., error recovery), or the like.

In some embodiments, the memory system 102 can transition between power states, such as between an active operating mode 142 and an idle mode 144, according to a mode control signal 140. For the active operating mode 142, the memory system 102 can maintain full power to the components therein. For the idle mode 144, the memory system 102 can remove or reduce power to one or more of the components, such as the memory controller 114, the memory array 116, portions therein, or a combination thereof. The idle mode 144 can decrease power 146 consumed by the memory system 102.

In entering the idle mode 144, the memory controller 114 can use a transition mechanism 148 to store a set of targeted operating parameters (e.g., register settings/values, dynamic memory data, operating system settings, and/or the like) into persistent memory, such as the embedded memory 124 or a designated portion of the memory array 116. Accordingly, when transitioning from the idle mode 144 to the active operating mode 142, the memory controller 114 can reestablish power and activate the targeted set of components and use the stored set of targeted operating parameters to reestablish and continue operations.

In addition to the commanded operating modes, the memory system 102 can further include a power control mechanism 150 (e.g., circuitry, software, firmware, or a combination thereof) configured to control the consumed power 146 according to dynamic/real-time conditions. For example, the power control mechanism 150 can cause the memory controller 114 to transition between the active operating mode 142 and a reduced power mode 152 independent of or without the mode control signal 140. In the reduce power mode 152, the memory system 102 can reduce or remove power to a circuit control set 154 that include the memory controller 114, the memory array 116, portions therein, or a combination thereof. Accordingly, the memory system 102 can reduce the consumed power 146 of the memory system 102 using the reduced power mode 152 with or without a command from the host device 104. The circuit control set 154 can at least partially overlap with the deactivated components of the idle mode 144.

The memory system 102 can use the transition mechanism 148 as described above to store the operating parameters in persistent memory when transitioning into the reduced power mode 152. Similarly, the memory system 102 can use the stored information to re-establish the operating conditions when transitioning from the reduced power mode 152 and/or to the active operating mode 142.

The control mechanism 150 can be configured to transition the memory system 102 from the active operating mode 142 to the reduced power mode 152 using a power control timer 156 and/or a time threshold 158. The memory system 102 can activate the power control timer 156 following a targeted activity, such as a received command, a response to the received command, or the like, associated with the host device 104. The time threshold 158 can be a limit for the power control timer 156 that triggers the transition from the active operating mode 142 to the reduced power mode 152. The time threshold 158 can be a comparison value for an up counter or an initial value for a down counter. Conversely, the control mechanism 150 can transition from the reduced power mode 152 and to the active operating mode 142 based on a wake-up timer, a communication received at the host interface 112, or the like.

Further, the control mechanism 150 can be configured to balance EOL parameters, such as an operating time and the number of transitions in to and/or out of the active operating mode 142. In some embodiments, the control mechanism 150 can be configured to track and compare an operating measure 162 and a switching measure 164. The operating measure 162 can correspond to an on-time for components. For example, the memory controller 114 can activate and continue a counter when operating in the active operating mode 142 and stop/pause the counter without resetting the counter value when the memory system 102 is in the idle mode 144 or the reduced power mode 152. The switching measure 164 can represent a total number of transitions into or out of the active operating mode 142 and the corresponding number of accesses to/from the persistent memory for the operating parameters.

The control mechanism 150 can be configured to dynamically adjust the control time threshold 158 according to the comparison between the operating measure 162 and the switching measure 164. In some embodiments, the control mechanism 150 can lengthen or increase the control time threshold 158 when the switching measure 164 exceeds or outpaces the operating measure 162. Accordingly, the control mechanism 150 can reduce the frequency of triggering the reduced power mode 152 and the corresponding access to the persistent memory for operating parameters going forward. Conversely, the control mechanism 150 can shorten or decrease the control time threshold 158 when the operating measure 162 exceeds or outpaces the switching measure 164. Accordingly, the control mechanism 150 can shorten the inactivity time before entering the reduced power mode 150 and decrease the duration of the active operating mode 142 going forward.

### Operational Adjustments

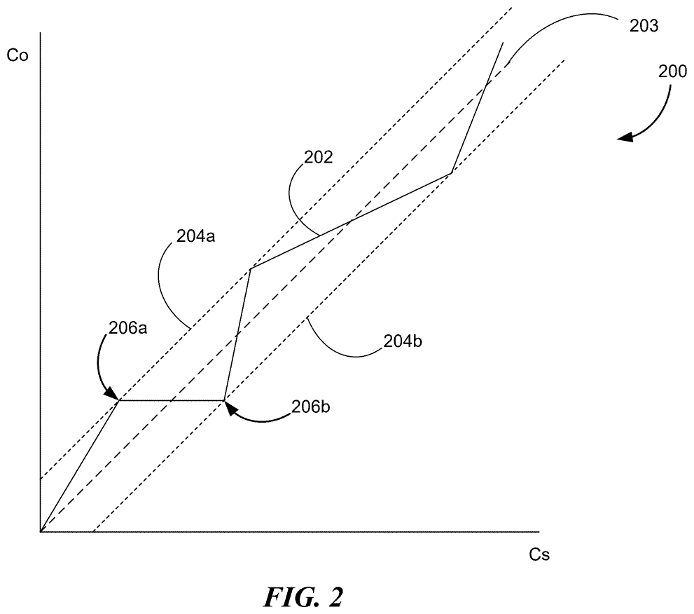

FIG. 2 is an illustration of a control profile 200 in accordance with an embodiment of the present technology. The control profile 200 can show a budget comparison 202, such as a result of comparing the operating measure 162 of FIG. 1 (shown as Co in FIG. 2) and the switching measure 164 of FIG. 1 (shown as Cs)). In some embodiments, the memory system 102 of FIG. 1 can compute the budget comparison 202 as a ratio of remaining or utilized budgets for Co and Cs. For the example illustrated in FIG. 2, Co can correspond to a percentage representation of the operating time with 100% representing the corresponding EOL requirement (e.g., 50,000 hours, 60,000 hours, etc.). Also, Cs can correspond to a percentage representation of the number transitions with 100% representing the corresponding EOL requirement (e.g., 15 million transitions, 20 million transitions, etc.). The memory system 102 can compute the budget comparison 202 using a predetermined equation/process and using the operating measure 162 and the switching measure 164 as inputs.

The power control mechanism 150 of FIG. 1 can be configured to maintain the budget comparison 202 about a balanced state 203 representative of even or balanced usage/depletion of the operating and switching budgets. In some embodiments, the power control mechanism 150 can be configured to adjust the control time threshold 158 of FIG. 1 using a set of comparison thresholds 204 that are established relative to (e.g., within a predetermined range of) the balanced state 203. For example, the comparison thresholds 204 can include an operating adjustment threshold 204a and a switching adjustment threshold 204b. The operating adjustment threshold 204a can correspond to the operating measure 162 exceeding or outpacing the switching measure 164 by a threshold amount, and the switching adjustment threshold 204b can correspond to the switching measure 164 exceeding or outpacing the operating measure 162 by the same or different threshold amount.

The power control mechanism 150 can use the comparison thresholds 204 to implement control adjustments 206, such as for adjusting the control time threshold 158. For example, the memory system 102 can operate the power control mechanism 150 to implement an operating adjustment 206a that reduces the control time threshold 158 when the budget comparison 202 reaches the operating adjustment threshold 204a. Accordingly, the power control mechanism 150 can transition to the reduced power state 152 of FIG. 1 earlier or after a shorter period of inactivity, thereby reducing the rate of accrual/budget consumption for the operating time budget. Also, the memory system 102 can operate the power control mechanism 150 to implement a switching adjustment 206b that increases the control time threshold 158 when the budget comparison 202 reaches the switching adjustment threshold 204b. Accordingly, the power control mechanism 150 can transition to the reduced power state 152 later or after a longer period of inactivity, thereby reducing the rate of accrual/budget consumption for the switching/transition budget.

### Control Flow

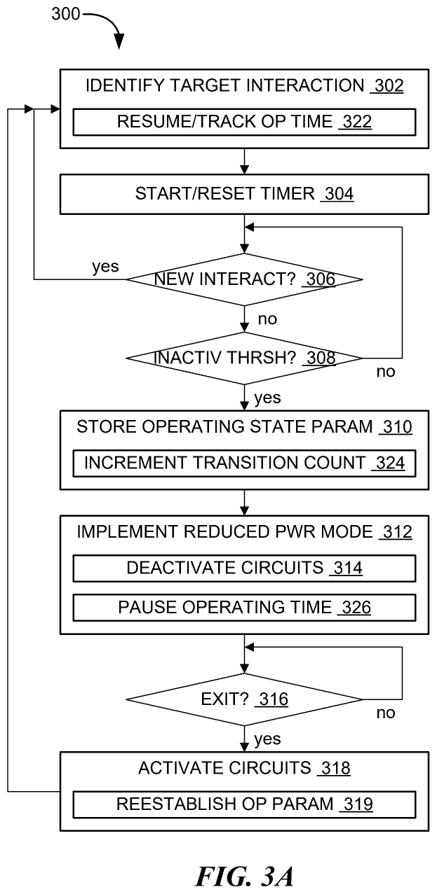

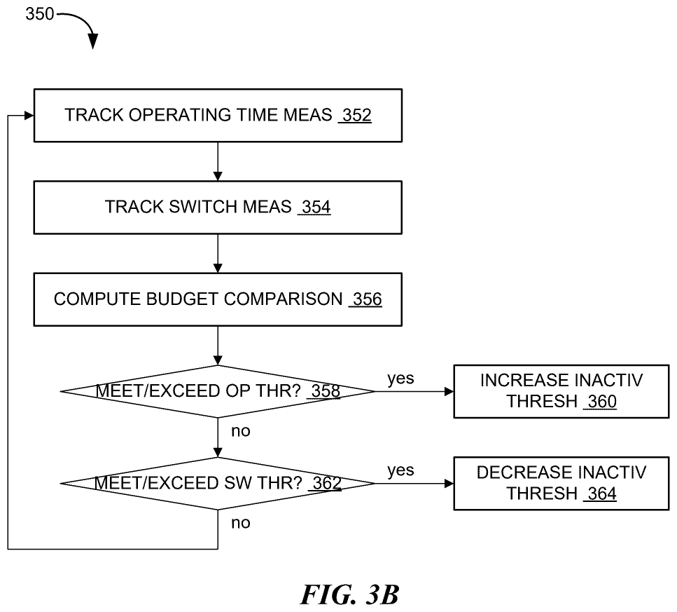

FIG. 3A is a flow diagram illustrating a first example method 300 of operating an apparatus (e.g., the memory system 102 of FIG. 1 or one or more components therein) in accordance with an embodiment of the present technology. The example method can be for implementing the power control mechanism 150 of FIG. 1 to transition between the active operating mode 142 of FIG. 1 and the reduced power mode 152 of FIG. 1.

At block 302, the memory system 102 can identify a targeted host interaction. For example, the memory system 102 can use the host interface 112 of FIG. 1, the processor 122 of FIG. 1, or a combination thereof to detect targeted communications/commands received from the host device 104 of FIG. 1. The memory system 102 can effectively distinguish interactions with the host device 104 from inactivity.

Along with identifying the host interaction, the memory system 102 can track an operating time as illustrated in block 322. For example, the host interface 112 or the processor 122 can maintain or continue to increment an operating counter while operating in the active operating mode 142 of FIG. 1. Accordingly, the memory system 102 can continue to track an overall operating time that represents the duration that the memory system 102 has operated in the active operating mode 142.

At block 304, the memory system 102 can reset and start the control timer 156 of FIG. 1 based on identifying the target interaction. Accordingly, the memory system 102 can measure a duration since the last/previous host interaction. Effectively, by resetting and starting the control timer 156 based on identifying the target interaction, the memory system 102 can measure a duration of inactivity.

At decision block 306, the memory system 102 can determine whether a new instance of the targeted host interaction has occurred. For example, the host interface 112 or the processor 122 can determine whether the new host interaction has occurred. When the new interaction occurs, the memory system 102 can determine whether the interaction corresponds to the targeted interaction as represented by the feedback loop to block 302.

Without a new interaction (e.g., as the duration of inactivity extends), the memory system 102 can determine whether the control timer 156 has reached an inactivity threshold (e.g., the control time threshold 158 of FIG. 1) as illustrated at decision block 308. The memory system 102 can continue the decision determination until the control timer 156 reaches the control time threshold 158.

At block 310, when the inactivity duration reaches the threshold, the memory system 102 can store operating state parameters. For example, the processor 122 and/or the array controller 128 of FIG. 1 can store one or more targeted operating parameters under the active operating mode 142 into the embedded memory 124 of FIG. 1 and/or the memory array 116 of FIG. 1. At block 324, the memory system 102 can increment a power state transition count or a corresponding counter.

At block 312, the memory system 102 can implement the reduced power mode 152. For example, the memory system 102 can deactivate circuits/components (e.g., the processor 122, the memory array 116, the array controller 128, etc.) according to the circuit control set 154 of FIG. 1 as illustrated in block 314. Accordingly, the memory system 102 can cause the corresponding circuits/components to operate in a lower power consumption state or remove power supplied to the corresponding circuits/components. The memory system 102 can implement or transition into the reduced power mode 152 without or independent of a directly related command and/or the mode control signal 140 of FIG. 1 from the host device 104.

At block 326, the memory system 102 can pause tracking of the operating time. For example, the memory system 102 can stop/pause the operating time counter in correspondence with transitioning out of the active operating mode 142.

At decision block 316, the memory system 102 can determine whether to exit the reduced power mode 152. For example, the host interface 112 or the processor 122 can detect a communication/command from the host interface and exit out of the reduced power mode 152. Additionally or alternatively, the interface 112 or the processor 122 can use an internal timer to limit the duration of the reduced power mode 152.

At block 318, in response to meeting the exiting condition, the memory system 102 can activate the circuits/components according to the circuit control set 154. As illustrated at block 319, the memory system 102 can reestablish the operating conditions according to the stored state parameters. Along with the reestablished settings, the memory system 102 can operate the circuits/components in the circuit control set 154 in a corresponding setting. For example, the memory system 102 can transition back into the active operating mode 142 in response to an operating command (e.g., write, read, etc. different from the mode control signal 140) from the host device 104. In reestablishing the active operating mode 142, the memory system 102 can continue/resume the operation time counter as illustrated by the feedback loop to block 302/322.

FIG. 3B is a flow diagram illustrating a second example method 350 of operating an apparatus (e.g., the memory system 102 of FIG. 1 or one or more components therein) in accordance with an embodiment of the present technology. The example method can be for implementing the power control mechanism 150 of FIG. 1 to dynamically adjust the control time threshold 158 (e.g., an inactive duration trigger).

At block 352, the memory system 102 can track an operating time measure (the operating measure 162 of FIG. 1). For example, the memory system 102 can measure the operating time under the active operating mode 142 as described above for blocks 322 and 326 of FIG. 3A.

The memory system 102 can further track the operating measure 162 based on computing/updating the operating measure 162 using the operating time, such as a representation of a budget remaining until a corresponding EOL condition (e.g., a predetermined value, such as 50,000 hours, 60,000 hours, etc.). In some embodiments, the memory system 102 can compute/update the operating measure 162 as a percentage representation of a consumed budget based on dividing the operating time by the EOL value.

At block 354, the memory system 102 can track a switching measure (e.g., the switching measure 164 of FIG. 1). For example, the memory system 102 can track the number of transitions in and/or out of the active operating mode 142 as described above for block 324 of FIG. 3A.

The memory system 102 can further track the switching measure 164 based on computing/updating the switching measure 164 using the switching count, such as a representation of a budget remaining until a corresponding EOL condition (e.g., a predetermined value, such as 15 million transitions, 20 million transitions, etc.). In some embodiments, the memory system 102 can compute/update the switching measure 164 as a percentage representation of a consumed budget based on dividing the transition count by the EOL value.

At block 356, the memory system 102 can compute the budget comparison 202 of FIG. 2. The memory system 102 can compute the budget comparison 202 using the switching measure and the operating time measure. For example, the memory system 102 can compute the budget comparison 202 based on comparing the switching measure 164 and the operating measure 162, such as by subtracting, dividing, and/or otherwise following a predetermined equation using the two measures. Accordingly, the budget comparison 202 can indicate a balance between the competing EOL conditions and show whether one measure is greater or outpacing the other and the corresponding magnitude.

At decision blocks 358 and 362, the memory system 102 can determine whether or not the budget comparison 202 has reached or exceeded a set of adjustment thresholds. In some embodiments, the set of adjustment thresholds can be predetermined ranges relative to (e.g., above and/or below) the balanced state 203 of FIG. 2. For example, when the budget comparison 202 is associated with a ratio between the operating measure 162 and the switching measure 164 (e.g., consumption percentage values of the total EOL requirements), the balanced state 203 can correspond to a value of 1.0 and the adjustment thresholds can be a threshold range above and below 1.0. Also, when the budget comparison 202 is associated with a difference between the operating measure 162 and the switching measure 164, the balanced state 203 can correspond to a value of 0.0 and the adjustment thresholds can be a threshold decimal range (e.g., +/−0.1) above and below 0.0.

Additionally or alternatively, the memory system 102 can dynamically calculate or adjust the set of adjustment thresholds based on the operating duration and/or the switching count. For example, the memory system 102 can use different adjustment thresholds (e.g., smaller ranges and closer to the balanced state 203) as the memory system 102 ages and progresses toward the EOL condition.

At decision block 358, the memory system 102 can determine whether the budget comparison 202 has reached or exceeded the operating adjustment threshold 204a of FIG. 2. Reaching or exceeding the operating adjustment threshold 204a can represent that the operating measure 162 is greater or outpacing the switching measure 164. Accordingly, at block 360, the memory system 102 can decrease the inactivity threshold, such as by decrease or shortening the control time threshold 158 of FIG. 1. By decreasing the control time threshold 158, the memory system 102 can shorten the wait/inactivity time before transitioning into the reduced power mode 152. As a result, the memory system 102 can decrease the time spent in the active operating mode 142 following the adjustment. The earlier transition can further correspond to an increase in the frequency/quantity of transitions into the reduced power mode 152 following the adjustment.

If the budget comparison 202 has not reached or exceeded the operating adjustment threshold 204a, the memory system 102 can determine whether the budget comparison 202 has reached or exceeded the switching adjustment threshold 204b of FIG. 2 as illustrated at decision block 362. Reaching or exceeding the switching adjustment threshold 204b can represent that the switching measure 164 is greater or outpacing the operating measure 162. Accordingly, at block 364, the memory system 102 can increase the inactivity threshold, such as by increasing or lengthening the control time threshold 158. By increasing the control time threshold, the memory system 102 can lengthen the wait/inactivity time before transitioning into the reduced power mode 152. As a result, the memory system 102 can increase the time spent in the active operating mode 142 following the adjustment. The delayed transition can further correspond to a decrease in the frequency/quantity of transitions into the reduced power mode 152 following the adjustment.

If the budget comparison 202 is between the set of thresholds (e.g., the operating adjustment threshold 204a and the switching adjustment threshold 204b) without meeting or exceeding them, the memory system 102 can maintain the current value of the control time threshold 158. As illustrated by the feedback loop to block 352, the memory system 102 can continue operations as described above until the measures become out of balance such that the budget comparison 202 meets or exceeds one of the thresholds.

### Overall System

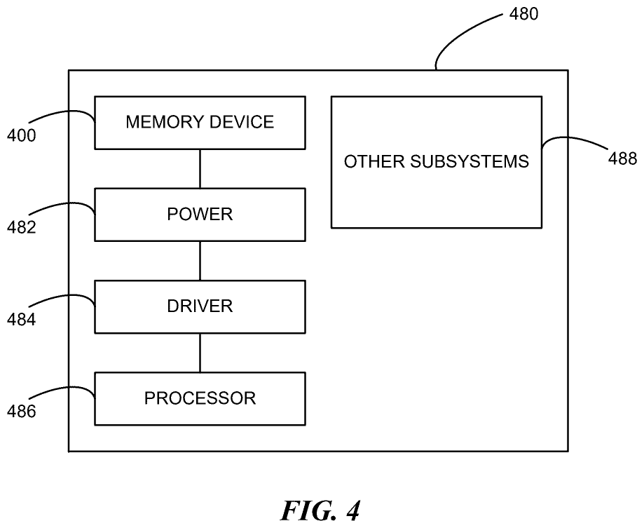

FIG. 4 is a schematic view of a system that includes an apparatus in accordance with embodiments of the present technology. Any one of the foregoing apparatuses (e.g., memory systems) described above with reference to FIGS. 1-3 can be incorporated into any of a myriad of larger and/or more complex systems, a representative example of which is system 480 shown schematically in FIG. 4. The system 480 can include a memory device 400, a power source 482, a driver 484, a processor 486, and/or other subsystems or components 488. The memory device 400 can include features generally similar to those of the apparatus described above with reference to one or more of the FIGS, and can therefore include various features for performing a direct read request from a host device. The resulting system 480 can perform any of a wide variety of functions, such as memory storage, data processing, and/or other suitable functions. Accordingly, representative systems 480 can include, without limitation, hand-held devices (e.g., mobile phones, tablets, digital readers, and digital audio players), computers, vehicles, appliances and other products. Components of the system 480 may be housed in a single unit or distributed over multiple, interconnected units (e.g., through a communications network). The components of the system 480 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash), magnetic storage media, phase-change storage media, ferroelectric storage media, dynamic random access memory (DRAM) devices, etc.

The term “processing” as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term “dynamic” as used herein describes processes, functions, actions or implementation occurring during operation, usage, or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

I/We claim:

1. A memory device, comprising:
a host interface configured to receive external communications from a host device;
a memory array configured to store and provide access to data; and
a memory controller operably coupled to the memory array and configured to:
track a control timer for measuring a lapsed idle time since a targeted event;
transition from an active operating mode to a reduced power mode when the lapsed idle time reaches a control time threshold, wherein the reduced power mode includes reducing or removing power consumed by the memory array, one or more components within the memory controller, or a combination thereof;
track an operating measure based on measuring a duration for the active operating mode;
track a switching measure based on counting the transition between the active operating mode and the reduced power mode; and
dynamically adjust the control time threshold based on comparing the operating measure and the switching measure, wherein the control time threshold is adjusted to balance the operating measure and the switching measure.

2. The memory device of claim 1, wherein:
the host interface is configured to receive a mode control signal from the host device; and
the memory controller is configured to:
in response to the mode control signal, transition from the active operating mode to an idle mode based on reducing or removing power consumed by the memory array, the one or more components within the memory controller, or a combination thereof; and
transition from the active operating mode to the reduced power mode independent of receiving the mode control signal and without notifying the host device.

3. The memory device of claim 2, wherein the memory controller is configured to:
transition from the active operating mode to the reduced power mode based on deactivating circuitry and/or components identified by a circuit control set; and
transition out of the reduced power mode by activating the circuitry and/or components identified by the circuit control set, wherein the transition out of the reduced power mode is triggered based on an activity at the host interface.

4. The memory device of claim 1, wherein the memory controller is configured to:
compute a budget comparison based on comparing the operating measure and the switching measure;
compare the budget comparison to a set of adjustment thresholds; and
dynamically adjust the control time threshold by increasing or decreasing the control time threshold according to the comparison between the budget comparison and the set of adjustment thresholds.

5. The memory device of claim 4, wherein:
the set of adjustment thresholds includes an operating adjustment threshold representative of the duration for the active operating mode exceeding or outpacing a count of the transition between the active operating mode and the reduced power mode; and
the control time threshold is dynamically adjusted by decreasing the control time threshold when the budget comparison reaches or exceeds the operating adjustment threshold.

6. The memory device of claim 4, wherein:
the set of adjustment thresholds includes a switching adjustment threshold representative of a count of the transition between the active operating mode and the reduced power mode exceeding or outpacing the duration for the active operating mode; and
the control time threshold is dynamically adjusted by increasing the control time threshold when the budget comparison reaches or exceeds the switching adjustment threshold.

7. The memory device of claim 4, wherein:
the budget comparison is a ratio between the operating measure and the switching measure;
the set of adjustment thresholds correspond to a first range above a targeted balanced state and a second range below the targeted balanced state; and
the targeted balanced state corresponds to the operating measure matching the switching measure.

8. The memory device of claim 1, wherein:
the operating measure represents a progress of the duration relative to an end-of-life (EOL) operating duration; and
the switching measure represents a progress of a current count of transitions of power states relative to an EOL transition count.

9. The memory device of claim 8, wherein the operating measure and the switching measure are each a ratio that indicates an EOL condition when the ratio reaches 1.0.

10. The memory device of claim 1, wherein:
the memory device is configured for implementation within a vehicle control system;
the memory array includes NAND memory cells; and
the memory controller is configured to store to a subset of the NAND memory cells a set of operating parameters before transitioning from the active operating mode to the reduced power mode,
wherein the operating parameters are used to reestablish operating settings when exiting out of the reduced power mode, and
wherein the switching measure represents a level of wear on the subset of the NAND memory cells caused by storing the operating parameters.

11. A method of operating a memory device, the method comprising:
tracking a control timer for measuring a lapsed idle time since a targeted event at the memory device;
transitioning from an active operating mode to a reduced power mode when the lapsed idle time reaches a control time threshold;
tracking an operating measure based on measuring a duration for operating the memory device in the active operating mode;
tracking a switching measure based on counting the transition into and/or out of the active operating mode; and
dynamically adjusting the control time threshold based on the operating measure and the switching measure.

12. The method of claim 11, further comprising:
transitioning out of the active operating mode in response to a corresponding communication from a host device, wherein the dynamically adjusted control time threshold is for transitioning into the reduced power mode independent of the communication from the host device.

13. The method of claim 11, further comprising:
computing a budget comparison based on comparing the operating measure and the switching measure;
wherein dynamically adjusting the control time threshold includes:
comparing the budget comparison to a set of adjustment thresholds; and
increasing or decreasing the control time threshold according to the comparison between the budget comparison and the set of adjustment thresholds.

14. The method of claim 11, wherein:
the operating measure represents the duration relative to a related end-of-life (EOL) operating duration; and
the switching measure represents a current count of transitions of power states relative to a related EOL transition count.

15. The method of claim 11, further comprising:
storing to a subset a set of operating parameters within the memory device before transitioning to the reduced power mode,
wherein the operating parameters are used to reestablish operating settings when exiting out of the reduced power mode, and
wherein the switching measure represents a level of wear or resource consumption caused by storing the operating parameters.

16. A memory device, comprising:
a memory array configured to store and provide access to data; and
a logic operably coupled to the memory array and configured to:
track an operating measure representative of a duration for operating the memory device in an active operating mode;
track a switching measure based on counting a transition between the active operating mode and a reduced power mode that operates the memory array or another component within the memory device at a lower power state; and
dynamically adjust a control time threshold based on the operating measure and the switching measure, wherein the control time threshold represents a threshold for an idle duration used for transitioning the memory device into the reduced power mode.

17. The memory device of claim 16, wherein the logic is further configured to:
track a control timer for measuring a lapsed idle time since a targeted event; and
transition the memory device from operating in the active operating mode to the reduced power mode when the control timer reaches the dynamically adjusted control time threshold.

18. The memory device of claim 16, wherein the logic is further configured to balance end-of-life (EOL) budgets related to the operating measure and the switching measure by dynamically adjusting the control time threshold.

19. The memory device of claim 16, wherein the logic is further configured to:
store a set of operating parameters for the active operating mode before transitioning to the reduced power mode; and
transition into and reestablish the active operating mode using the set of operating parameters, wherein the switching measure represents a level of wear or resource consumption associated with storing and/or accessing the set of operating parameters.

20. The memory device of claim 16, wherein the logic is further configured to dynamically adjust the control time threshold by selecting between:
increasing the control time threshold for increasing the operating measure faster than the switching measure for one or more subsequent transitions into the reduced power mode, and
decreasing the control time threshold for increasing the operating measure slower than the switching measure for the one or more subsequent transitions into the reduced power mode.
